(19) United States
(12) Patent Application Publication
(10) Pub. No.: US 2021/0138889 A1
(43) Pub. Date: May 13, 2021

(54) Hybrid drivetrain having a combustion powertrain and an electrical powertrain

(71) Applicant: Schaeffler Technologies AG & Co. KG, Herzogenaurach (DE)

(72) Inventors: Sebastian Köpfler, Bühl (DE); Bernhard Walter, Oberkirch-Haslach (DE)

(73) Assignee: Schaeffler Technologies AG & Co. KG, Herzogenaurach (DE)

(21) Appl. No.: 17/044,463

(22) PCT Filed: Jan. 22, 2019
(86) PCT No.: PCT/DE2019/100057

§ 371 Date: Oct. 1, 2020

(30) Foreign Application Priority Data
Apr. 19, 2018 (DE) 102018109349.7
Jul. 4, 2018 (DE) 102018116122.0

(51) Int. Cl. B60K 6/50; B60K 6/24; B60K 6/26; B60K 6/38; B60K 6/365; B60K 6/48

(52) U.S. Cl. CPC B60K 6/50; B60K 6/24; B60K 6/26; B60K 6/38; B60Y 2400/80; B60K 6/48; B60K 2006/4808; B60Y 2200/92; B60Y 2400/73; B60K 6/365

(57) ABSTRACT

A hybrid drivetrain includes an output element, a combustion powertrain, an electrical powertrain, and a torque-transmitting, fixed-speed reduction gearing connected to the output element for reducing a speed of the internal combustion engine and the electric machine. The combustion powertrain has an internal combustion engine with a drive shaft for delivering a first torque, a generator with a generator shaft for converting the first torque into electrical energy, a variable transmission arranged to variably transmit the first torque, and a torque clutch for connecting and disconnecting transmission of the first torque between the internal combustion engine and the output element. The electrical powertrain has an electric machine with a rotor shaft for delivering a second torque. In an example embodiment, the torque-transmitting, fixed-speed reduction gearing has a direct combustion input stage for the combustion powertrain and a direct electrical input stage for the electrical powertrain.

### CROSS-REFERENCE TO RELATED APPLICATIONS

This application is the United States National Phase of PCT Appln. No. PCT/DE2019/100057 filed Jan. 22, 2019, which claims priority to German Application Nos. DE102018109349.7 filed Apr. 19, 2018 and DE102018116122.0 filed Jul. 4, 2018, the entire disclosures of which are incorporated by reference herein.

### TECHNICAL FIELD

The disclosure relates to a hybrid drivetrain having a combustion powertrain and an electrical powertrain, both for the needs-based provision of torque to an output element. The combustion powertrain has at least the following components: an internal combustion engine; a generator; a variable transmission; and a torque clutch for connecting and disconnecting a torque transmission from the internal combustion engine to the output element. The electrical powertrain includes at least one electric machine. The hybrid drivetrain also includes a torque-transmitting, fixed speed reduction gearing connected to the output element for reducing a speed of the internal combustion engine and the electric machine. The hybrid drivetrain may be characterized in that the reduction gearing has a direct combustion input stage and a direct electrical input stage; the variable transmission is offset in parallel to and/or axially overlaps the internal combustion engine; and/or only a single-stage fixed-speed torque transmission drive is provided as an axial extension of the drive shaft.

Alternatively, the hybrid drivetrain may be characterized in that a torque clutch with three switching states is provided on the input side of the variable transmission.

### BACKGROUND

Hybrid drivetrains for motor vehicles are known from the prior art, in which an internal combustion engine, usually a gasoline engine or diesel engine, and an electric machine are provided. The electric machine is configured to drive the motor vehicle, generally via the output thereof, usually two drive wheels. The electric machine is connected in parallel or in series. With a full hybrid or PHEV hybrid, an electric machine is configured to independently drive the motor vehicle. In addition, an internal combustion engine is configured together with a generator to generate electrical energy, by means of which an accumulator can be charged. Some of these full hybrids are configured so that the internal combustion engine and/or the generator can deliver to the output element, at least to increase the torque of the electric machine, for example for so-called boosting.

In addition, it is known that a belt transmission, for example a continuous variable transmission (CVT), is used as a variator for a continuously variable transmission between the internal combustion engine and the output element. This makes it possible to always operate the internal combustion engine at the optimal load point.

In the prior art, at least the generator is arranged as an extension to the internal combustion engine. The generator is then coupled to the internal combustion engine via a direct connection or via a single gear stage. In many applications, it is problematic that the installation space in an engine compartment is limited because, for example, this has a conventional design and is therefore sufficient for only one conventional internal combustion engine and one alternator (generator alone for engine torque absorption). Therefore, complex measures must be taken to reduce the space required for the units.

### SUMMARY

In the following, reference will be made to the combustion axis, i.e., the (theoretical) axis of the combustion engine if the axial direction, radial direction or the circumferential direction and corresponding terms are used unless explicitly stated otherwise. Unless explicitly stated otherwise, ordinal numbers used in the previous and subsequent descriptions are used only for the purposes of clear distinction and do not indicate the order or ranking of the designated components. An ordinal number greater than one does not necessarily mean that another such component must be present. If a reduction is used in the following, this means a translation ratio of less than 1. If, on the other hand, translation is referred to, this is not limited to a translation ratio greater than 1, unless explicitly stated or mentioned as the opposite of the reduction. The translation ratio is always related to the speed.

The disclosure relates to a hybrid drivetrain, having at least the following components: an internal combustion engine having a drive shaft for delivering a torque; a generator having a generator shaft for converting a torque into electrical energy; an electric machine having a rotor shaft for delivering a torque; a belt transmission, which is configured to continuously translate a torque of the drive shaft; an output element as a consumer of a torque input by the internal combustion engine and/or the electric machine; and a torque clutch for connecting and disconnecting a torque transmission to the output element.

In an example embodiment, the transmission device (reduction stage) of the internal combustion engine branch arranged after the belt transmission (CVT variator) and the transmission stage(s) of the electrical power branch arranged after the electric machine are combined in a planetary stage with an upstream spur gear stage which is coupled to the differential.

Furthermore, the hybrid drivetrain may include an intermediate wheel for flexible connection of the electric machine; a toothed chain stage arranged upstream of the CVT variator, which can have a translation ratio of 1; a separating element such as a clutch, e.g., a dog clutch between the CVT variator and the tooth chain stage; and a generator arranged upstream of the variator with a fixed translation ratio to the internal combustion engine. The generator may be designed as a motor generator, which can also generate a torque.

The structure of the hybrid drivetrain proposed here has only one toothed chain stage or one spur gear stage in the extension to the internal combustion engine and after the damper/two-mass flywheel. The rest of the transmission is arranged on the side of the internal combustion engine (cumbustor) to the rear, i.e., parallel to the longitudinal axis of the internal combustion engine.

Known hybrid drivetrains are usually provided with separate double reduction stages in the torque flow from the internal combustion engine branch and from the electromotive branch to the differential. These redundant reduction stages can now be omitted because they are combined in a planetary gear and a single upstream spur gear stage. As a result, a reduction stage can be omitted in each of the internal combustion engine and electomotive branch. This results in fewer shafts and bearings, which results in improved efficiency. Furthermore, an additional intermediate gear can be arranged for a more flexible connection of the electric machine and for optimal dimensioning of all spur gear stages. The planetary gear used is connected upstream of a differential (preferably: a spur gear differential) and can be integrated therein.

The use of the integrated planetary gear and the associated dismantling of the redundant structures result in advantages in terms of installation space and further integration of the individual gear elements in the overall drive.

A separating element may be arranged between the toothed chain stage and the CVT variator so that the internal combustion engine can be disconnected while the generator E-machine (motor generator) is driven via the CVT variator. The generator (motor generator) may be arranged upstream of the CVT variator so that the variator does not have to be operated under charge when generating electrical power and the variator spread can be used when driving with the generator E-machine.

Alternatively or additionally, the disclosure further relates to a hybrid drivetrain including a combustion powertrain and an electrical powertrain, both for the needs-based provision of torque to an output element. The combustion powertrain has at least the following components: an internal combustion engine having a drive shaft for delivering a torque; a generator having a generator shaft for converting a torque into electrical energy; a variable transmission which is configured to variably translate a torque of the drive shaft; and a torque clutch for connecting and disconnecting a torque transmission from the internal combustion engine to the output. The electrical powertrain includes at least one electric machine with a rotor shaft for delivering a torque. The hybrid drivetrain further includes a torque-transmitting, fixed-speed reduction gearing connected to the output element for reducing a speed of the internal combustion engine and the electric machine.

In an example embodiment, the reduction gearing has a direct combustion input stage for the combustion powertrain and a direct electrical input stage for the electrical powertrain.

In another example embodiment, the variable transmission of the combustion powertrain is offset in parallel and/or axially overlaps the internal combustion engine.

In another example embodiment, only a single-stage, fixed-speed torque transmission drive is provided in an axial extension of the drive shaft for torque transmission by means of the variable transmission to the output element.

In another example embodiment, a torque clutch with three switching states is provided on the input side of the variable transmission.

According to one embodiment, the hybrid drivetrain is formed according to at least two of the alternative embodiments mentioned here.

The hybrid drivetrain is configured to drive the available energy for as long as possible, subject to the lowest possible carbon dioxide emissions of the internal combustion engine. For this purpose, a comparatively large accumulator is usually provided, which stores electrical energy. If possible, the accumulator should be plugged into an external energy source for charging, as a so-called plug-in hybrid. This purely electrical operation (switching state 1: electric machine or the electrical powertrain and/or the motor generators is the only drive), is expected to result in an overall more efficient (electrical) energy generator, such as conventional large power plants and so-called renewable (electrical) energy generators, reduced carbon dioxide emissions, and reduced emissions of hazardous substances, such as nitrogen oxides and fine dust, in the direct environment of large gatherings of people. The internal combustion engine should only be put into operation when the battery is in a low state of charge or when the operating state is optimal for the internal combustion engine (overland travel at constant driving speed) (switching state 2: internal combustion engine or the combustion powertrain as a drive without an electric machine). Alternatively, the internal combustion engine is switched to support a constant charge (switching state 3: electric machine and internal combustion engine form the drive).

According to a further aspect, in order to achieve a high torque, only the internal combustion engine (corresponding to switching state 3) or only the generator, e.g., as a so-called motor generator, is suitable as an electric machine for torque output (switching state 4a: purely electric boosting or purely electric driving) or the (motor) generator and the internal combustion engine (switching state 4b: overall system boosting or overall system driving) are switched to boost the torque output or to increase the torque output of the electric machine for a longer period of time. Furthermore, if the battery is in a low state of charge, electric energy is to be generated as a precaution or for direct consumption by means of the internal combustion engine and the generator. In one case (switching state 5a: charging without combustion-side input power), the output is still driven solely by the electric machine or the output does not absorb any torque. In another case, torque is additionally output from the internal combustion engine to the output element (switching state 5b: charging with auxiliary drive power from the combustion side).

The internal combustion engine may be a piston engine with a crankshaft as the drive shaft. The drive shaft may include at least one torque damper, for example a dual-mass flywheel and/or a centrifugal force pendulum, in order to decouple torque vibrations superimposed on the torque output with high efficiency from the rest of the drivetrain. Such a torque damper may be arranged in the torque flow upstream of the belt transmission.

As can be seen from the above description, the generator is configured to absorb a torque via its generator shaft and convert it into electrical energy. In an example embodiment, the (motor) generator can be connected according to switching state 4b via its generator shaft to the output for torque delivery in a torque-transmitting manner. Furthermore, the generator and/or the electric machine of the electrical powertrain can be connected in a torque-transmitting manner for torque absorption so that the inertial energy of the output, or of a moving motor vehicle, is converted into electrical energy when decelerating and fed into an accumulator (switching state 6: recuperation, i.e., electrical braking with electrical energy recovery via the adjustable magnetic resistance in the generator or the electric machine of the electrical powertrain). The internal combustion engine may be decoupled from the output element. Alternatively or additionally, the generator is electrically connected directly to the electric machine via an inverter so that electrical energy generated on the generator is made available directly for use in the electric machine.

The electric machine of the electrical powertrain is optimized for delivering high torque with efficient consumption, and may be configured for torque absorption, i.e., recuperation. In a high-torque electric machine, the rotor shaft is permanently connected to the output element without a separating clutch. The electric machine is then connected in such a way that it outputs a torque at the output element with every reduction in power. In the case of an internal combustion engine with high torque compared to the electric machine, an additional separating clutch or a freewheel may be provided between the rotor shaft and the output element.

While a required speed range and torque range can often be covered by means of electric machines without variable translation, the speed range is limited in a usable torque range of an internal combustion engine in such a way that a variable translation is necessary. For this purpose, a variable transmission is provided in the combustion powertrain. This is configured to translate a torque of the drive shaft in a variable manner. Such a variable transmission is, for example, a switchable gear step transmission, a belt transmission, for example a push chain drive, or other known or still to be developed transmissions. The ratio may be changed using an automatic system because there is often no connection between the speed of the motor vehicle and the engine speed. The input side of the variable transmission is the side for torque absorption from the internal combustion engine and the output side of the variable transmission is the side for torque output to the output element. This by no means excludes that a torque may run in the opposite direction, for example for recuperation from the output element to the generator.

In addition, a torque clutch is provided in the combustion powertrain, which enables the connection and disconnection of a power output to the output element. The torque clutch is, for example, a friction clutch, wherein a relative speed can be adjusted by slipping, or a dog clutch, wherein no or only a low relative speed to the output or the input (speed to be reduced) to the output element may exist. According to one embodiment, the torque clutch is designed as a so-called wedge clutch with a hub cone and a (rounded) polygonal driver cone, e.g., with a corresponding receiving cone designed as a solid body spring. With such a wedge clutch, it is possible to switch between relative speeds of 20 to 30 rpm [revolutions per minute] because the engagement is not purely form-fitting, but rather force-fitting. The speed of the generator can be freely adjusted and the speed of the drive shaft of the internal combustion engine can be adjusted relatively precisely, at least after starting. As a result, the relative speed can be regulated to zero, or at least brought close enough to zero so that such a clutch can be switched in (almost) any state. A torque clutch, in which slip at high relative speeds is permissible, is therefore not necessary.

A reduction gearing is provided for the output, both for the electrical powertrain and for the combustion powertrain, by means of which combustion-side speeds (halved engine speed after reduction with rigid and/or variable pilot gear) in the range from above 250 rpm [two hundred and fifty revolutions per minute] to 3,500 rpm [three thousand five hundred revolutions per minute] or more are reduced to the required rotational speeds of drive wheels, for example tires, of approximately 70 rpm (corresponds to approximately 10 km/h [ten kilometers per hour] for a tire with a diameter of approximately 75 cm [seventy-five centimeters]) to about 1,500 rpm (equivalent to about 200 km/h).

Because the electric machine of the electrical powertrain generally has a very different speed to the shaft on the combustion side for torque output at the output element, a separate gear has been provided for the electric machine. The shaft on the combustion side for torque output at the output element is hereinafter referred to as the output shaft.

Here, however, it is now proposed to dispense with a separate transmission on the electric side. Instead, the reduction gearing has a direct combustion input stage for the combustion powertrain and a direct electrical input stage for the electrical powertrain. A direct (reduction) stage is a device for single-stage torque transmission.

In one embodiment, for example, no further gear wheels are provided between the output shaft of the internal combustion powertrain and the reduction gearing, and/or no further gear wheel between the rotor shaft of the electric machine and the reduction gearing. Rather, the reduction gearing has a single receiving shaft, for example with a spur gear for the output shaft and a spur gear for the rotor shaft, so that both the combustion powertrain and the electrical powertrain have a direct torque-transmitting effect on the (common) receiving shaft of the reduction gearing.

In one embodiment, the reduction gearing has a receiving shaft and a coaxial reduction stage, e.g., designed as one or a plurality of planetary gear stages. The coaxial reduction stage is thus a structural component of the reduction gearing, and such a reduction gearing can be manufactured as a structural unit and can be preassembled without the need for disassembly before installation in an application. The coaxial reduction stage forms an intermediate receptacle for the electrical powertrain, wherein the electric machine of which is referred to as high-speed, for example a speed of up to 18,000 rpm [eighteen thousand revolutions per minute] or even 25,000 rpm. This is advantageous for a high torque or, for example, a smaller radial expansion of the electric machine, i.e., a high power density.

In one embodiment, the receiving shaft has a single (receiving) spur gear. An intermediate gear may be provided between the rotor shaft and the receiving spur gear. This intermediate gear merely forms an intermediate gear for maintaining a required center distance between the electric machine of the electrical powertrain and the reduction gearing or differential.

In one embodiment, the rotor shaft acts on a separate (first receiving) spur gear of the receiving shaft and the output shaft on another (second receiving) spur gear of the receiving shaft.

In one embodiment, multiple of the mentioned embodiments are combined with one another, for example an intermediate gear with a coaxial reduction stage for the electrical powertrain, wherein the coaxial reduction stage interacts with a further reduction stage and the latter further reduction stage simultaneously forms a torque absorption for the combustion powertrain.

In each of the above-mentioned embodiments, the electrical powertrain therefore has no reduction gear of its own or no off-axis reduction gear. This saves at least radial and/or axial installation space on the electrical side. Shafts and bearings are also eliminated, which improves efficiency.

In addition to the variable transmission and a speed-fixed combustion stage, and optionally a speed-fixed generator stage, the combustion powertrain may have no further transmission changing the speed of the drive shaft of the internal combustion engine or the generator shaft of the generator.

According to one aspect, it is optionally proposed that the variable transmission can be connected to the drive shaft in a torque-proof manner so that a torque that can be changed continuously is transmitted to the output shaft of the combustion powertrain. There is no slipping torque clutch, for example a friction clutch. This means that additional axial space is gained in the combustion powertrain.

By reducing the stages or integrating the stages into the (common) reduction gearing of both powertrains, an increased efficiency can be achieved compared to a conventional arrangement.

In a hybrid drivetrain in an alternative or additional embodiment, the variable transmission of the combustion powertrain is offset in parallel and/or axially overlaps the internal combustion engine.

This embodiment is independent of the above-mentioned embodiment of the hybrid powertrain insofar as the reduction gearing does not necessarily have a direct combustion input stage for the combustion powertrain and a direct electrical input stage for the electrical powertrain. Otherwise, reference is made to the preceding description.

For some applications, the axial installation space for the internal combustion engine, whether installed transversely or longitudinally to the direction of travel of the motor vehicle, is already exhausted by the axial overall length of the internal combustion engine. It may be advantageous to arrange a large part of the units in parallel and/or axially overlapping the internal combustion engine. To date, it has been believed that it is generally more advantageous if an offset of the torque-transmitting shaft towards the output is taken over by the variable transmission. However, it has been found that the installation space next to the internal combustion engine offers sufficient installation space when cleverly nested because the internal combustion engine does not have the shape of a cuboid, but in part (also as an in-line engine) a V-shape and recesses.

In an alternative or additional embodiment of the hybrid drivetrain, only a single-stage, fixed-speed torque transmission drive is provided in an axial extension of the drive shaft for torque transmission by means of the variable transmission to the output element. Here it is proposed to form the torque transmission to the variable transmission by means of a single-stage, fixed-speed torque transmission drive, for example a single-stage traction drive, for example a chain drive, or a single gear stage. This results in fewer shafts and bearings, which results in improved efficiency. A parallel offset may thus be formed. The chain drive creates the advantage of a translation-independent distance between the input shaft of the variable transmission and the drive shaft. The gear stage may have an even higher level of efficiency.

Between the drive shaft and the single-stage, fixed-speed torque transmission drive, only one damper, for example a dual-mass flywheel, may be provided. The axial space required in the extension of the internal combustion engine is thus small.

The generator may be arranged parallel to the internal combustion engine, e.g., connected to the generator shaft directly or via a fixed-speed, e.g., single-stage, transmission to the input shaft of the variable transmission. The variable transmission, for example a belt transmission, is thus connected downstream of both the generator shaft and the drive shaft of the internal combustion engine. The generator and the internal combustion engine are thus connected to one another in a fixed-speed, torque-transmitting manner. However, a detachable torque transmission clutch may be provided between the generator and the internal combustion engine, e.g., between the drive shaft of the internal combustion engine and the variable transmission. The generator is permanently connected to the variable transmission and thus permanently torque-transmitting. A further torque transmission clutch is then connected downstream of the variable transmission so that the torque transmission between the output and the combustion powertrain can be interrupted with this further torque transmission clutch.

In an alternative or additional embodiment, the hybrid drivetrain may be provided with a torque clutch with three switching states on the input side of the variable transmission. According to this embodiment, the torque clutch is interposed between the variable transmission and the internal combustion engine or the generator. The torque clutch may be connected directly, i.e., without further transmission elements, to the (single) input shaft of the variable transmission. It should be pointed out again that the shaft of the variable transmission, which has a variable speed due to its variability of the translation of the fixed-speed translation or non-translated speed of the internal combustion engine and/or the generator, is referred to as the output shaft of the variable transmission. This output shaft is configured on the output side of the variable transmission for torque output to the output element. The input shaft is configured to absorb the torque from the internal combustion engine and/or from the generator. In spite of this nominal assignment as input shaft or input side and output shaft or output side, for example for recuperation and/or use of the engine braking of the internal combustion engine, a reverse torque curve is possible via the variable transmission.

According to an example embodiment, the torque clutch includes a plurality of separating clutches so that three switching states can be represented. However, according to this embodiment, the torque clutch is arranged only at a single location in the torque transmission train, e.g., as a structural unit. For example, the torque clutch for the separating clutches has a common actuating device and/or a coaxial hollow shaft guide.

The torque clutch or at least one of the separating clutches may be designed as a separating clutch that can only be switched without a relative speed. For example, the separating clutch is designed as a dog clutch. The separating clutch may be designed as a so-called wedge clutch with a hub cone and a (rounded) polygonal driver cone, e.g., with a corresponding receiving cone designed as a solid body spring. With such a wedge clutch, it is possible to switch between relative speeds of 20 to 30 rpm [revolutions per minute] because the engagement is not purely form-fitting, but rather force-fitting. The speed of the generator can be freely adjusted. As a result, the relative speed can be regulated to zero, or at least brought close enough to zero so that such a clutch can be switched in (almost) any state. A separating clutch, in which slip at high relative speeds is permissible, is therefore not necessary.

In a further example embodiment of the hybrid drivetrain, the drive shaft, the generator shaft and the rotor shaft point in the same axial direction. For many applications, it is advantageous to use an already fully developed internal combustion engine. An internal combustion engine generally has a single direction of rotation, which is not only advantageous in terms of control technology, but is also determined by mechanical circuitry, for example the camshaft for controlling the fuel inlet and exhaust gas outlet. In order to avoid an expensive special solution, such an internal combustion engine should be used, which is configured, for example, for clockwise torque delivery. Turning to the right corresponds to turning counterclockwise when looking at the internal combustion engine from the torque connection side.

In the embodiment proposed here, a generator with any orientation can now be used with the opposite but also the same direction of rotation. Thus, in the opposite direction of rotation, for example, a chain drive or ring gear drive can be used in the internal combustion engine, in which, in contrast to a (single) spur gear stage, there is no reversal of the direction of rotation, while the generator has a (single) spur gear stage, or vice versa. With the same direction of rotation, an odd or even number of spur gear stages or a chain drive (e.g., on the internal combustion engine) or ring gear drive (e.g., on the generator) is used in both.

The axial direction of the generator with respect to the internal combustion engine, i.e., the side of the torque connection, is the same here. A feedback shaft can thus be used parallel to the drive shaft, while the generator is connectable or connected to this feedback shaft in the same direction of rotation for torque transmission with a single spur gear stage.

The internal combustion engine is designed with a right-hand or left-hand torque connection, i.e., the output element of the drive shaft. The torque-free transmission between the variable transmission and the drive shaft and the torque-free transmission between the variable transmission and the generator shaft are to be coordinated with one another according to the desired direction of rotation.

With this additional degree of freedom, an optimal efficiency can be configured for a large or small parallel offset of the input shaft of the variable transmission to the drive shaft of the internal combustion engine so that this does not have to be reduced due to space requirements.

In a further example embodiment of the hybrid drivetrain, the torque clutch in the combustion powertrain is configured for keeping at least two of the following three switching states a. to c. ready:

a. the generator and the internal combustion engine are connected to the output element in a torque-transmitting manner;

b. a combustion-side torque transmission to the output element is interrupted and the generator is only connected to the internal combustion engine in a torque-transmitting manner; and

c. on the combustion side, only the generator or only the internal combustion engine is connected to the output element in a torque-transmitting manner.

In this embodiment, only a single torque clutch is provided in the combustion powertrain, i.e., only a single torque clutch for interrupting a torque transmission from the combustion powertrain to the output element. Such a torque clutch includes two separating clutches or forms a separating clutch with three different positions. For the sake of clarity, the torque clutch is described here in detail as two separate separating clutches, wherein a single separating clutch has one shift state less than two separating clutches. For example, only a first torque connection between a first input shaft and the output shaft or only a second torque connection between a second input shaft and the output shaft and a disconnected position, i.e., no torque transmission, can be mapped. For example, a torque connection between all three shafts is possible at the expense of the disconnected position or one of the two torque connections.

The torque clutch may be configured as a double shifting element with three possible switching states. The internal combustion engine may be connected to the variable transmission only when the generator is also connected to the variable transmission. Alternatively, the internal combustion engine can be connected to the output element in a torque-transmitting manner without the generator. The generator can then be connected to the variable transmission only when the internal combustion engine is also connected to the variable transmission. In addition to connecting (switching state a.) and interrupting (switching state b.) a torque transmission, a further (internal branching on the combustion side) switching state c. is thus possible.

The double switching element is locally limited and can be operated with a single supply line and control line. This saves installation space, but also simplifies assembly and maintenance. The additional switching state c. is configured for a separate connection of the internal combustion engine or the generator to the output element. All of the above-mentioned switching states of the hybrid drivetrain can thus be mapped by means of this double switching element alone. For some applications, however, it is sufficient only to be able to map the switching states b. and a. or c., wherein the generator and the internal combustion engine have a permanently fixed torque or are connected to one another by means of a (passive) slip clutch.

In switching state a., boosting is possible, with an additional slip clutch toward the output element, starting by means of the generator and simultaneous charging operation possible. This corresponds to a serial/parallel operation.

In the switching state b., purely electric driving with only the electrical powertrain, charging in the combustion powertrain or the internal combustion engine and generator, starting by generator with or without slip clutch to the output element is possible. In one embodiment without a slip clutch, the internal combustion engine must be brought up to speed, until a speed adjustment to the electrical powertrain for switching to switching state a. is reached. This corresponds to a serial operation.

If the power output of the electrical powertrain is to be boosted solely by a generator (purely electrical operation with boosting and/or recuperation), switching state c.1 is advantageous. In an alternative embodiment, switching state c.2 is advantageous if an increase in the torque delivered by the electric machine of the electrical powertrain to the output element is only desired additionally by an internal combustion engine without the generator being dragged along. In the case of a double switching element which can represent four switching states, e.g., the switching states a., b., c.1 and c.2 can be mapped.

In a further example embodiment of the hybrid drivetrain, the generator shaft is connected to the variable transmission in a torque-transmitting manner by means of a torque transmission unit including a ring gear and reducing the speed. In this embodiment, for example with a planetary roller gear, a large reduction ratio from the generator shaft to the combustion powertrain or to the output is made possible in a small (radial) installation space. At the same time, there is no speed reversal here, which, as described above, opens up additional degrees of freedom in the alignment and arrangement of the hybrid drivetrain units.

The torque transmission may be carried out in one stage by means of the ring gear. In this embodiment, the installation space is small insofar as a translation ratio, as is possible with a planetary roller gear, is not required. This applies to conventional starter generators, which had to be integrable as a replacement for a conventional alternator in a less complex belt drive with regard to their speed and torque.

In a further embodiment of the hybrid drivetrain, the variable transmission is designed as a belt transmission with a continuously adjustable translation ratio. In this embodiment, the variable transmission is configured as a continuously variable belt transmission, for example as a continuous variable transmission (CVT) or thrust link drive. The belt transmission is configured to always deliver a torque of the drive shaft of the internal combustion engine to the output element at the desired speed. The translation ratio can be adjusted continuously and without an additional manual transmission, for example. In addition, a torque of the output element and/or the generator shaft can always be delivered to the internal combustion engine at the desired speed via the belt transmission. The internal combustion engine can thus be operated at an optimal charge point over wide ranges of the required speed at the output, e.g., over the entire required speed range. The pollutant emissions of the internal combustion engine can thus be reduced further. The efficiency of a belt transmission can now be brought close to the efficiency of a single-stage spur gear so that these losses in efficiency are low compared to non-optimal operation of the internal combustion engine.

The generator and the internal combustion engine may be connected in a torque-transmitting manner on the transmission input side. If, as proposed here, the generator is connected to the belt transmission on the input side, i.e., on the combustion side, the generator can be tuned directly to the present speed of the drive shaft of the internal combustion engine, without taking into account the translation ratio on the belt transmission. In addition, a radial or parallel overlap is made possible from the output side of the belt transmission with the reduction gearing if the generator is arranged coaxially or offset in parallel by a one-stage transmission in overlap with the input side of the belt transmission.

In a further embodiment of the hybrid drive train, the invariable, i.e., fixed-speed, reduction gear is designed as a differential or is structurally integrated into a differential. Due to the possibility of setting up a speed-fixed torque transmission between the electrical powertrain and the output element, and at the same time a need for a large reduction ratio between a conventional electric machine and the output element, it is advantageous in terms of installation space to design the reduction gearing as a differential or to integrate it into the differential of the output element. A differential designed as a reduction gearing is, for example, a differential in which each stage, including the compensation stages, has a reduction ratio not equal to 1. A reduction gearing integrated in a differential is, for example, only structurally integrated in such a way that the differential forms a structural unit with the compensation stages and the at least one reduction stage. Such a reduction differential may be arranged coaxially with the two driven shafts of the output element.

The differential may be designed as a spur gear differential. A spur gear differential, also referred to as a planetary differential or planetary roller differential, requires a small amount of space. In addition, high torques can be transmitted at low bearing loads. The power shaft-side receiving shaft or receiving stage of the spur gear differential may be formed in one piece in a fixed-torque manner for the combustion powertrain and the electrical powertrain. In an example embodiment, at least one reduction stage can also be integrated in the spur gear differential, wherein a very small space is achievable with a suitable design. A high reduction ratio is advantageous, for example, for high-speed drive units with low torque.

According to a further aspect, a motor vehicle is proposed which has a hybrid drivetrain according to an embodiment as described above, wherein the output element has at least one drive wheel. Motor vehicles with a hybrid drivetrain have a small installation space due to the large number of individual drive components. It is therefore advantageous to use a hybrid drivetrain of small size or with a flexible arrangement of the components.

This problem is exacerbated for passenger cars in the small car class according to European classification, but also for passenger cars in the upper and middle class, for which a long range combined with high performance is required. The functional units used in a passenger car of the small car category are not significantly reduced in size compared to passenger cars of larger car categories. Nevertheless, the available installation space for small cars is considerably smaller. The hybrid drivetrain proposed here can be designed compactly and is particularly flexible with regard to the arrangement of the components.

The generator shaft may not be arranged in an axial extension of the drive shaft, but the generator may be arranged axially overlapping in parallel to the internal combustion engine. In addition, a simple concept of a torque clutch can be used, with which all desired switching states can be set slip-free. In an example embodiment, a torque clutch is provided only on the input side of the variable transmission, for example as a double shift element.

Passenger cars are assigned to a vehicle category according to, for example, size, price, weight, and performance. This definition is subject to constant change based on the needs of the market. In the US market, vehicles in the small car and microcar categories are assigned to the subcompact car category according to European classification, while in the British market they correspond to the super-mini car and city car categories respectively. Examples of the microcar category are the Volkswagen up! or Renault Twingo. Examples of the small car category are the Alfa Romeo Mito, Volkswagen Polo, Ford Fiesta or Renault Clio. Well-known full hybrids in the small car category are the BMW i3, Audi A3 e-tron or Toyota Yaris Hybrid. Mid-class hybrid cars (according to the US definition: mid-size car or intermediate car) are currently the BMW 330e iPerformance (plug-in hybrid) and Prius 1.8 VVT-i. Upper-class hybrid cars (according to the US definition: full-size car) are currently the BMW 740e (plug-in hybrid) and Panamera Turbo SE-Hybrid from Porsche.

### BRIEF DESCRIPTION OF THE DRAWINGS

The disclosure described above is explained in detail below based on the relevant technical background with reference to the associated drawings, which show example embodiments. The disclosure is in no way restricted by the purely schematic drawings, although it should be noted that the drawings are not dimensionally accurate and are not suitable for defining proportions. In the following,

FIG. 1 shows a hybrid drivetrain in a motor vehicle as a rear-wheel drive;

FIG. 2 shows sections of a combustion powertrain with a double switching element;

FIG. 3 shows sections of a hybrid powertrain with a common receiving shaft on the reduction gearing;

FIG. 4 shows a section of a hybrid powertrain with a common input shaft and separate combustion input stage and electrical input stage;

FIG. 5 shows a hybrid drivetrain with belt transmission;

FIG. 6 shows a section of an electrical powertrain with two reduction stages for the electric machine; and

FIG. 7 shows a hybrid drivetrain with a ring gear for the generator.

### DETAILED DESCRIPTION

FIG. 1 shows a hybrid drivetrain 1 in a motor vehicle 24. All components are shown schematically. The generator 8 is designed as a starter generator (for driving the internal combustion engine 6) or as a motor generator (for driving the output element 4, 5). The internal combustion engine 6 (combustion engine, combustor, ICE) is shown as a 6-cylinder internal combustion engine, but can also have a different number of cylinders. However, the advantage of the hybrid drivetrain's axial compactness is particularly large if an internal combustion engine 6 is used that has a relatively long axial construction, for example a 6-cylinder in-line engine.

In FIG. 1 the hybrid drivetrain 1 is shown in a motor vehicle 24 as a rear-wheel drive, i.e., with a left drive wheel 4 and a right drive wheel 5 of the rear axis 31 as an output element. The hybrid drivetrain 1 is optionally arranged transversely to the longitudinal axis 26. This means that here the combustion axis 27, the generator shaft 28 and the rotor axis 29 are arranged transversely to the longitudinal axis 26 and parallel to the rear axis 31. Alternatively, the hybrid drivetrain 1 is arranged longitudinally or at least one motor axis is arranged transversely and at least one other motor axis is arranged longitudinally. The hybrid drivetrain 1 is also optionally arranged behind the driver's cab 25 and independently thereof. Alternatively, the hybrid drivetrain 1 is at the front, i.e., in front of the driver's cab at or above the front axis 32.

The hybrid drivetrain 1 includes a combustion powertrain 2 and an electrical powertrain 3, each of which is bordered here by a dashed box. The electrical powertrain 3 has an electric machine 13 with a rotor shaft 14 and is connected by means of an electric input stage 17 in a torque-transmitting manner to the reduction gearing 15 with the output element 4, 5 to the rear axis 31, which is constructed with a differential 42, for example a bevel gear differential. The internal combustion powertrain 2 comprises an internal combustion engine 6, which here is shown schematically as a 6-cylinder piston motor with a clockwise rotating drive shaft 7 (see first direction of rotation 20) is shown, and furthermore a generator 8 with a counterclockwise rotating generator shaft 9 (see second direction of rotation 21), and a variable transmission 10.

The internal combustion engine 6 can be connected to the input side 33 of the variable transmission 10 in a torque-transmitting manner by means of a dual-mass flywheel 30 via a torque transmission drive 18 designed here as a traction mechanism drive with, for example, a chain as a traction means 19. The generator 9 is also connected to the input side 33 of the variable transmission 10 in a torque-transmitting manner by means of a one-stage (here spur gear) torque transmission unit 23. In contrast to the generator 8, the internal combustion engine 6 can be separated from the input side 33 of the variable transmission 10 by means of a (second) torque clutch 12, for example a wedge clutch. The output side 34 of the variable transmission 10 can be connected to the reduction gearing 15 via a combustion input stage 16. Here, a (first) torque clutch 11 is provided, so that the combustion powertrain 2 can be completely separated from the output 4, 5. The first torque clutch 11 is also preferably slip-free, for example as a dog clutch. Optionally, only the first torque clutch 11 or only the second torque clutch 12 is provided.

FIGS. 2 to 7 show variants of the architecture of a hybrid drivetrain 1, which can be used in a motor vehicle 24 as shown in FIG. 1 to replace the corresponding components there. Therefore, reference is made to the description of FIG. 1. However, this is not to be understood as limiting. For example, the hybrid drivetrain 1 can be used to drive a front axis 32 or for all-wheel drive.

FIG. 2 shows a section of a combustion powertrain 2 of a hybrid drivetrain 1 as shown, for example, in FIG. 1. On the one hand, a double shift element locally combines the first torque clutch 11 and the second torque clutch 12. For this purpose, the generator 8 is guided through an input side 33 of the variable transmission 10 designed as a hollow shaft and can be switched to the input side 33 and separately switched to the internal combustion engine 6 (here a section of the torque transmission drive 18 can be seen with traction means 19) or both be separated. Likewise, the internal combustion engine 6 can be connected and disconnected separately to both, i.e., the generator 8 and the variable transmission 10. On the other hand, the variable transmission 10 is indicated here as a belt transmission with a belt 35, which enables a stepless transmission between the input side 33 and the output side 34 (see FIG. 1), so that the internal combustion engine 6 can be operated in an always optimal speed range.

FIG. 3 shows a section of a hybrid drivetrain 1. Here the reduction gearing 15 is integrated into a differential 42, which is designed here as a spur gear differential. The reduction gearing 15, i.e., the electrical input stage 17 and the combustion input stage 16, and the at least one (first) reduction stage 37 may form a structural unit with the differential 42. The differential 42 includes a left compensation stage 38 for torque transmission to the left drive wheel 4 (see FIG. 1) and a right compensation stage 39 for torque transmission to the right drive wheel 5. The compensation stages 38, 39 distribute a torque introduced via the reduction gearing 15 to the left drive wheel 4 and the right drive wheel 5, for example conventionally, after a respective decrease in torque or decrease in speed. In one embodiment, one (in this exemplary embodiment, the same) reduction ratio based on the speed of less than 1 is also integrated in the compensation stages 38, 39. The compensation stages 38 and 39 are not necessarily identical and the left compensation stage 38 is not necessarily arranged on the left of the right compensation stage 39.

The reduction gearing 15 here in FIG. 3 has a common receiving shaft 36 with a single spur gear. This receiving shaft 36 forms both the combustion input stage 16 (for example with the output side 34 of the variable transmission 10, see FIG. 1) and the electrical input stage 17. The electrical input stage 17 also has an intermediate wheel 41, which serves to produce a desired center distance. The input stages 16 and 17 are followed by the (here only common first) reduction stage 37, in which a fixed ring gear has been selected purely by way of example, the receiving shaft 36 enters the torque via a sun gear, and the left compensation stage 38 and the right compensation stage 39 in each case are movable with a planetary carrier. The left compensation stage 38 and the right compensation stage 39 can be driven via a planetary carrier and the left drive wheel 4 or the right drive wheel 5 are connected in a torque-transmitting manner by means of the respective sun gear. It should be explicitly pointed out that the differential 42 shown, which is designed as a spur gear differential, is selected only as an example and can be replaced by another suitable connection.

FIG. 4 shows a section of a hybrid drivetrain 1, which is almost identical to the illustration in FIG. 3 for the sake of clarity and in this respect reference is made to the preceding description. In contrast to the embodiment according to FIG. 3, a receiving shaft 36 with two spur gears is shown, wherein one of the spur gears forms the combustion input stage 16 (on the right in the illustration) and the other spur gear forms the electrical input stage 17. An intermediate gear 41 in the electrical input stage 17 has been omitted here.

FIG. 5 shows a hybrid drivetrain 1, in which, for the sake of clarity, the part of the detail shown in FIG. 4 is identical to that shown there, and in this respect reference is made to the preceding description. Furthermore, the configuration of the electrical powertrain 3 is mirrored identically and the combustion powertrain 2 is similar to that shown in FIG. 1 and in this respect reference is made to the associated description. In contrast to the configuration of the internal combustion powertrain 2 according to FIG. 1, the internal combustion engine 6 and the generator 8 are arranged mirrored here, wherein the axial direction 22 of the drive shaft 7 and the generator shaft 9, but also the first direction of rotation 20 of the drive shaft 7 and the second direction of rotation 21 of the generator shaft 9, are the same. This is the case because here the torque transmission drive 18 of the internal combustion engine 6 as well as the torque transmission unit 23 are designed as a single-stage spur gear. A direction of rotation in the same direction in the torque transmission is thus entered on the input side 33 of the variable transmission 10. The variable transmission 10 is designed here as a belt transmission, e.g., as a CVT.

FIG. 6 shows the electrical powertrain 3 and the reduction gearing 15 and the differential 42 of the hybrid powertrain 1, as can be used in the architecture of the hybrid drivetrain 1 according to the embodiment in FIG. 5 to replace the components shown. The electric machine 13 is designed to rotate at high speed so that the speed range is significantly higher than is desired for the integrated receiving shaft 36 for an integrated combustion input stage 16. Therefore, a second reduction stage 40 is provided here as a preliminary stage to the first reduction stage 37, which, however, is only set up for reducing the speed of the high-speed electric machine 13 and, for this purpose, is connected to the first reduction stage 37 of the reduction gearing 15 in a torque-transmitting manner. In the selected configuration, the torque input of the electric machine 13 initially runs via a single-stage electrical input stage 17, as is the case, for example, in the architecture of the hybrid drivetrain 1 according to FIGS. 4 and 5. Above, the torque runs into the second reduction stage 40, namely into a rotationally fixed connected (second) sun gear, then onto the (second) planetary gears, which are mounted on a planetary carrier that is connected to the common receiving shaft 36 in a rotationally fixed manner, further onto a (second) ring gear on the (first) planet carrier of the first reduction stage 37. The first reduction stage 37 is based on the combustion powertrain 2 identical to that in FIGS. 4 and 5. For the sake of clarity, the left compensation stage 38 and the right compensation stage 38 are also designed as described above.

For the sake of clarity, FIG. 7 shows an almost identical configuration of the hybrid drivetrain 1, as shown in FIG. 5, in which case the generator shaft 9 of the generator 8 is connected to the input side 33 of the variable transmission 10 in a torque-transmitting manner via a single-stage torque transmission unit 23 comprising a ring gear. The second direction of rotation 21 of the generator shaft 9 is thus opposite the first direction of rotation 20 of the drive shaft 7.

With the hybrid drivetrain proposed here, a space-saving architecture that can be flexibly adapted to the respective space requirements is achieved.

REFERENCE NUMERALS

| | |
|---|---|
| 1 | Drivetrain |
| 2 | Combustion powertrain |
| 3 | Electrical powertrain |
| 4 | Left drive wheel |
| 5 | Right drive wheel |
| 6 | Internal combustion engine |
| 7 | Drive shaft |
| 8 | Generator |
| 9 | Generator shaft |
| 10 | Variable transmission |
| 11 | First torque clutch |
| 12 | Second torque clutch |
| 13 | Electric machine |
| 14 | Rotor Shaft |
| 15 | Reduction gearing |
| 16 | Combustion input stage |
| 17 | Electrical input stage |
| 18 | Torque transmission drive |
| 19 | Traction means |
| 20 | First direction of rotation |
| 21 | Second direction of rotation |
| 22 | Axial direction |
| 23 | Torque transmission unit |
| 24 | Motor vehicle |
| 25 | Driver's cab |
| 26 | Longitudinal axis |
| 27 | Combustion axis |
| 28 | Generator axis |
| 29 | Rotor axis |
| 30 | Dual-mass flywheel |
| 31 | Rear axis |
| 32 | Front axis |
| 33 | Input side |
| 34 | Output side |
| 35 | Belt |
| 36 | Receiving shaft |
| 37 | First reduction stage |
| 38 | Left compensation stage |
| 39 | Right compensation stage |
| 40 | Second reduction stage |
| 41 | Intermediate gear |
| 42 | Differential |

1.-10. (canceled)

11. A hybrid drivetrain comprising:
an output element;
a combustion powertrain comprising:
an internal combustion engine comprising a drive shaft for delivering a first torque;
a generator comprising a generator shaft for converting the first torque into electrical energy;
a variable transmission arranged to variably transmit the first torque; and
a torque clutch for connecting and disconnecting transmission of the first torque between the internal combustion engine and the output element;
an electrical powertrain comprising:
an electric machine comprising a rotor shaft for delivering a second torque; and
a torque-transmitting, fixed-speed reduction gearing connected to the output element for reducing a speed of the internal combustion engine and the electric machine.

12. The hybrid drivetrain of claim 11, wherein the torque-transmitting, fixed-speed reduction gearing comprises a direct combustion input stage for the combustion powertrain and a direct electrical input stage for the electrical powertrain.

13. The hybrid drivetrain of claim 12, wherein the variable transmission of the combustion powertrain is offset in parallel or axially overlaps the internal combustion engine.

14. The hybrid drivetrain of claim 12, wherein only a single-stage, fixed-speed torque transmission drive is provided as an axial extension of the drive shaft for torque transmission by the variable transmission to the output element.

15. The hybrid drivetrain of claim 12, further comprising a torque clutch with three switching states on an input side of the variable transmission.

16. The hybrid drivetrain of claim 11, wherein the variable transmission of the combustion powertrain is offset in parallel or axially overlaps the internal combustion engine.

17. The hybrid drivetrain of claim 16, wherein only a single-stage, fixed-speed torque transmission drive is provided as an axial extension of the drive shaft for torque transmission by the variable transmission to the output element.

18. The hybrid drivetrain of claim 16, further comprising a torque clutch with three switching states on an input side of the variable transmission.

19. The hybrid drivetrain of claim 11, wherein only a single-stage, fixed-speed torque transmission drive is provided as an axial extension of the drive shaft for torque transmission by the variable transmission to the output element.

20. The hybrid drivetrain of claim 19, further comprising a torque clutch with three switching states on an input side of the variable transmission.

21. The hybrid drivetrain of claim 11, further comprising a torque clutch with three switching states on an input side of the variable transmission.

22. The hybrid drivetrain of claim 11, wherein the drive shaft, the generator shaft and the rotor shaft point in the same axial direction.

23. The hybrid drivetrain of claim 11, wherein the torque clutch is arranged for at least two of the following three switching states:
connecting the generator and the internal combustion engine to the output element in a torque-transmitting manner;
interrupting a combustion-side torque transmission to the output element and connecting the generator to only the internal combustion engine in a torque-transmitting manner; and
connecting only the generator or only the internal combustion engine to the output element in a torque-transmitting manner.

24. The hybrid drivetrain of claim 11, further comprising a torque transmission unit with a ring gear, wherein the generator shaft is connected to the variable transmission in a torque-transmitting manner by the torque transmission unit.

25. The hybrid drivetrain of claim 24, wherein the torque transmission unit connects the generator shaft to the variable transmission in a single stage, speed-reducing manner.

26. The hybrid drivetrain of claim 11, wherein the variable transmission is designed as a belt transmission having a continuously adjustable translation ratio.

27. The hybrid drivetrain of claim 26, wherein the generator and the internal combustion engine are connected on an input side of the transmission in a torque-transmitting manner.

28. The hybrid drivetrain of claim 11, wherein the fixed-speed reduction gearing is designed as a spur gear differential.

29. The hybrid drivetrain of claim 11, wherein the torque-transmitting, fixed-speed reduction gearing is designed as a differential or is structurally integrated into a differential.
